(19) United States
(12) Patent Application Publication
(10) Pub. No.: US 2025/0252498 A1
(43) Pub. Date: Aug. 7, 2025

(54) SYSTEM AND METHOD FOR FAMILY ADVISOR SAFETY NET

(71) Applicant: Wells Fargo Bank, N.A., San Francisco, CA (US)

(72) Inventors: Carrie Anne Hanson, Charlotte, NC (US); Jordan D. Vardon, Matthews, NC (US)

(21) Appl. No.: 18/153,784

(22) Filed: Jan. 12, 2023

(51) Int. Cl. G06Q 40/06; G06Q 40/08

(52) U.S. Cl. CPC G06Q 40/06; G06Q 40/08

(57) ABSTRACT

Various examples are directed to computer-implemented systems and methods for a family advisor safety net. A method includes receiving a next generation input indicating desired investment activity of a next generation user and identity of a guardian of the next generation user, and receiving a guardian account input including information regarding an account of the guardian to be used by the next generation user and associated guardrail information. A family safety net platform is generated by linking the next generation user to the guardian account for the desired investment activity, and customized guardrails are calculated for the family safety net platform using the associated guardrail information. Limited access by the next generation user is provided to the guardian account using the customized guardrails for the family safety net platform, and proceeds from investment activity of the next generation user are dynamically divided between the guardian and the next generation user.

### TECHNICAL FIELD

This document relates generally to computer systems and more particularly to systems and methods for a family advisor safety net.

### BACKGROUND

The next generation of financial consumers have begun to value non-traditional forms of financial investments (e.g., cryptocurrency, NFTs, more volatile financial products, “meme stocks,” etc.) over traditional forms of financial investments (e.g., “safe” stocks, bonds, mutual funds, etc.). This is partly due to a heavier reliance on social media (e.g., via TikTok, SnapChat, Instagram Reels, Reddit and certain subreddits, etc.) for financial and investment information as well as a distrust of established financial institutions. These non-traditional financial investment instruments carry the possibility of a high reward but are also inherently high-risk investments. As such, next generation consumers who solely invest in such risky financial instruments are at a much higher risk of significant financial loss. Furthermore, these next generation consumers are often relatively young and likely have limited capital as they have not yet had time to grow their wealth.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates an example embodiment of a method for a family advisor safety net, according to various embodiments;

FIG. 1B illustrates an example embodiment of a method for using a family advisor safety net, according to various embodiments;

FIG. 2 illustrates an exemplary infrastructure for use in the present subject matter, according to various embodiments;

FIG. 3 illustrates an example machine learning module for a family advisor safety net, according to various embodiments;

FIG. 4 illustrates a flowchart of a method of training a model for a family advisor safety net, according to various embodiments; and

FIG. 5 is a block diagram of a machine in the example form of a computer system within which a set of instructions may be executed, for causing the machine to perform any one or more of the methodologies discussed herein.

### DETAILED DESCRIPTION

Next generation users of financial services, such as children or young adults, may not seek out competent financial advisors but instead take unnecessary financial risks due to lack of oversight or competence. In addition, next generation users are often relatively young and likely have limited capital as they have not yet had time to grow their wealth.

The present subject matter provides systems and methods for a family safety net platform which allows the next generation user to invest in high-risk financial instruments with the backing of a guardian account (e.g., that of parents, grandparents, etc.) to offset some of the risk. The safety net platform may have customized guardrails in place to help mitigate financial losses, while also allowing these next generation individuals to become exposed and partake in investment activity and build financial literacy.

A family safety net platform may allow guardian users to be linked with a dependent user (e.g., a next generation user or consumer). The family safety net platform may allow the guardian user to permit a next generation user access to a portion of the guardian user's funds in exchange for at least a portion of the dependent user funds. Alternatively, the guardian user funds may function as collateral offsetting the risk of loss, and the next generation user may only actually invest his or her own funds. These funds may be invested in one or more non-conventional financial instruments of the next generation user's choice (or a combination of the dependent user and guardian user's choice). As such, the guardian user may take on the inherent risk from non-conventional financial instruments while allowing both the next generation user (also referred to herein as a dependent user) and guardian user to benefit if the investment is successful. As used herein, the term “guardian” refers to a parent, step-parent, legal guardian, grandparent, or any relative of the next generation user, any individual that the next generation user may inherit from, or any individual that may have a financial interest in the next generation user. As used herein, the term “next generation user” refers to anyone investing in high risk financial products, any dependent of a guardian, any relative of a guardian, any individual that may inherit from a guardian, or any individual that may have a financial interest in a guardian.

The family safety net platform may also allow both the guardian user and next generation user to set up customized guardrails to mitigate the risk of financial loss. The customized guardrails may be calculated or determined by the safety net platform of the present subject matter, in some examples. In one example, funds may no longer be automatically invested in a financial instrument if the value of the financial instrument falls below a threshold amount. Additionally, the portion of funds available for investment may be limited at first and may increase over time or if certain milestones are achieved.

Milestones may include a particular percent return on investment, value of profit earned from investments, etc. In some cases, the family safety net platform may use a blockchain and/or smart contracts to calculate and/or implement the guardrails and/or milestones.

The family safety net platform may also facilitate a dynamic division of profit between the guardian user and next generation user. For example, initially the guardian user may take only a small percentage of any realized profit and the next generation user may receive the bulk of the profit to grow their wealth. However, over time, if the investments are successful and realized profit has increased, the guardian user may receive a greater share of profit, and the next generation user may receive less profit until they are determined to be financially independent. In various examples, other distributions of investment returns may alternatively be specified by the parties or determined by the present subject matter.

In various embodiments, the present subject matter may provide an investment platform which links a guardian user with a next generation user and is configured to permit the next generation user to use an allocated portion of the guardian user's funds (or to utilize the guardian user's funds as collateral) and enforce one or more rules according to configured guardrails. In some examples, a collective account is provided for investment purposes, including the use of customized guardrails which may act to control and/or prevent use of collective funds for certain investments or under certain conditions. In various examples, the present system provides for generating alerts regarding potential investments and assigns rules to individual users associated with the linked account. In some embodiments, the present system aggregates transaction data for the members of a family, allowing members of the family to share funds for investment purposes.

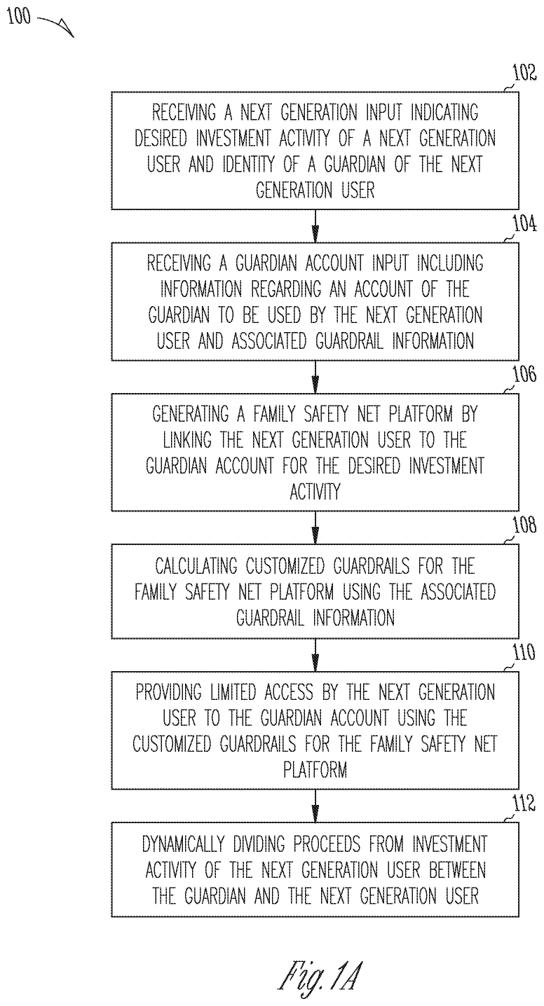

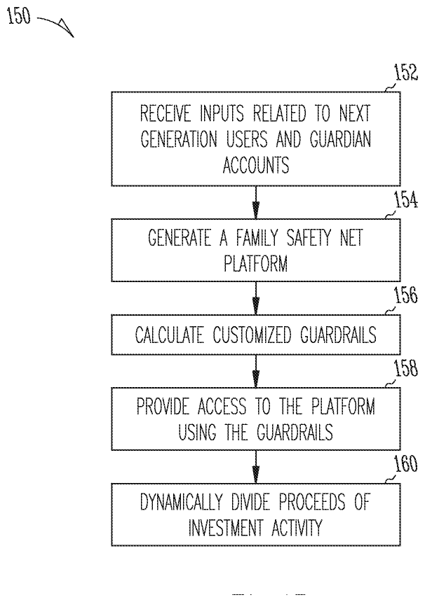

FIG. 1A illustrates an example embodiment of a method for a family advisor safety net, according to various embodiments. The method 100 may include receiving a next generation input indicating desired investment activity of a next generation user and identity of a guardian of the next generation user, at step 102. Next generation input may include identifying information of the next generation user, including but not limited to demographic information, financial information, desired investment activity or accounts of the next generation user, in various embodiments. At step 104, the method may include receiving a guardian account input including information regarding an account of the guardian to be used by the next generation user and associated guardrail information. Guardian account input may include, but is not limited to, demographic information, financial information, or accounts of the guardian, in various embodiments. The method may include generating a family safety net platform by linking the next generation user to the guardian account for the desired investment activity, at step 106. The system may link the next generation user by providing a digital connection or other type of linking, in various embodiments. At step 108, the method may include calculating customized guardrails for the family safety net platform using the associated guardrail information. In various embodiments, calculating customized guardrails for the family safety net platform may include determining an allocated portion of funds in the guardian account accessible by the next generation user. Calculating the customized guardrails for the family safety net platform includes using a blockchain, smart contracts, or machine learning, in various embodiments.

At step 110, the method may include providing limited access by the next generation user to the guardian account using the customized guardrails for the family safety net platform. In various examples, providing limited access by the next generation user to the guardian account may include calculating one or more milestones, wherein the next generation user is provided access to an increased portion of funds in the guardian account if the one or more milestones are achieved. Calculating the one or more milestones for the family safety net platform may include using a blockchain, using smart contracts, or using machine learning, and may include a percent return on investment or a value of profit earned from the investment activity, in various embodiments. At step 112, the method may include dynamically dividing proceeds from investment activity of the next generation user between the guardian and the next generation user. The investment activity of the next generation user may include investment in a financial instrument, and the next generation user may be prevented from investing funds from the guardian account in the financial instrument if a value of the financial instrument falls below a threshold amount, in various embodiments.

The guardian may be notified based on activity of the next generation user and using the customized guardrails and/or milestones, in various embodiments. In various examples, notifying the guardian includes providing a customized display on a device accessible by the guardian. The method may further include providing a selectable level of oversight by the guardian over the next generation user, in various embodiments. In some embodiments, the method may include triggering notifications to a guardian of next generation user or to a financial advisor based on one or more thresholds related to the selectable level of oversight.

Various embodiments of the present subject matter relates to a safety net for next generation users or investors. Next generation users may not have the same level of investment experience, wealth, or investment opportunity as their parents or guardians. The present subject matter may provide access by next generation or dependent users to funds of a guardian user to make investments. In some examples, the present subject matter provides a safety net based on a financial arrangement or agreement between the guardian user and the dependent user, and may select guidelines whereby mechanics of financial instruments and access to accounts for financial instruments may be controlled. In some examples, the safety net may provide a lower limit for an investment value and transfer investments or contributions to other instruments based on the lower limit. For example, if the selected investment instrument value falls below the lower limit (or guardrail), the safety net platform may automatically stop further funds from being transferred to the selected investment instrument (or even remove previously invested funds from the selected investment instrument) and begin investing in a different investment instrument. In various examples, the safety net may be partially or entirely coded in smart contracts or block chain. For example, if a goal of investment activity meets a threshold, a smart contract may automatically move investment dollars to alternative investments. The safety net may provide for a dependent user to select more risky investments but provide for overdraft protection, backup account protection, and opportunities for guardian users to set restrictions or requirements with smart contract protections, in various embodiments.

In various embodiments, the safety net provides a platform where accounts are protected, users may approve or set guidelines on risk tolerance, provide input for investments, guarantee or provide collateral for investments, and ensure that accounts do not fall below a prescribed level. In some examples, the platform provides alerts or automatic switching of investments to protect user funds. In some examples, a financial advisor may recommend the safety net platform as a tool to clients for their dependents, or the platform may be self-service and available generally by online access. In various examples, the financial advisor may be assigned a percentage of profits, and/or a share of profit may be assigned to the guardian user. The safety net platform may provide overdraft protection, in some embodiments. For example, the platform may protect the guardian parent account and if an investment value drops below a predetermined or calculated amount or floor. In accepting risk, the guardian user may share in profits from dependent investment activity above a certain level, in some embodiments. The platform may be part of a financial services app for user devices, in various embodiments.

The present platform may appeal to next generation users and provide an interface between guardian users and next generation users, in various embodiments, and create and foster understanding of financial investments for the next generation user. The platform may include firewall protection, in some examples. The guardian user and next generation user may use the same or different interfaces to interact with the platform, in various examples. The platform may provide for a method of introducing a next generation user to investment activity and potentially build a future relationship between the next generation user and a financial institution or advisor, in various examples. The platform provides for investment by the next generation user in a variety of instruments, including but not limited to, traditional and non-traditional investments like crypto-currency, tech stocks, instruments outside of a guardian user's investment risk threshold, short-term bond mutual funds, or stocks. In some examples, if a guardian user's investment is performing above a threshold, some of the funds may be directed to an account of a next generation user. For example, if the guardian user is receiving a 5 percent return but was expecting 4 percent, the extra one percent may be moved into a separate account of the next generation user such as a checking or savings account, or into the linked account.

The present platform may be used as an educational tool for each user, such that investment information is shared between users of the platform based on successful investment returns. In some examples, the platform may provide for competitions between guardian users and next generation users, with messaging going back in forth, where users may opt-in for push notifications to let users know about returns on investment of other users, and provide an option to the users to invest in instruments that other users are successfully using. The platform may include a display to be able to demonstrate to users how investments of other users are performing, in various embodiments. In some examples, the platform may provide reminders to review performance of financial instruments to increase or decrease investment in the instrument. The platform may provide a next generation user with a limited control over investments that is variable based on performance of the investments of the next generation user or the guardian user, in various examples.

FIG. 1B illustrates an example embodiment of a method for using a family advisor safety net, according to various embodiments. According to various embodiments, the method 150 may include receiving inputs related to next generation users and guardian accounts, at step 152. The inputs may include identifying information of the next generation user including but not limited to demographic information, financial information, desired investment activity or accounts of the next generation user, in various embodiments. The inputs may further include demographic information, financial information, or accounts of the guardian, in various embodiments. The method 150 may also include generating a family safety net platform, at step 154. The family safety net platform may include a specialized computer system for providing the next generation user with an interface to access guardian accounts, and providing the guardian user with an interface to monitor the next generation access, and may further include customized or dedicated computer storage or memory for the next generation user and/or the guardian relating to the use of the platform, in various embodiments.

The method 150 continues at step 156, where customized guardrails may be calculated for the for the family safety net platform, in various examples. In various embodiments, calculating customized guardrails for the family safety net platform may include determining an allocated portion of funds in the guardian account accessible by the next generation user. Calculating the customized guardrails for the family safety net platform may include using a blockchain, smart contracts, or machine learning, in various embodiments. At step 158, the method 150 may include providing access to the family safety net platform using the customized guardrails. In various examples, providing access may include providing limited access by the next generation user to the guardian account, or providing access to the guardian to the family safety net platform. Providing limited access may include calculating one or more milestones, wherein the next generation user is provided access to an increased portion of funds in the guardian account if the one or more milestones are achieved. Calculating the one or more milestones for the family safety net platform may include using a blockchain, using smart contracts, or using machine learning, and may include a percent return on investment or a value of profit earned from the investment activity, in various embodiments.

At step 160, the method may include dynamically dividing proceeds of investment activity between the next generation user and the guardian, in various embodiments. The next generation user may be prevented from investing funds from the guardian account in the financial instrument if a value of the financial instrument falls below a threshold amount, in various embodiments. In various examples, the family safety net platform may be configured to enforce one or more rules for the investment activity according to the customized guardrails. The family safety net platform may be configured to use the customized guardrails to control or prevent use of collective funds of the guardian and the next generation user for selected investments under programmable conditions, in various examples. Programmable conditions may be calculated or based on input from the next generation user or the guardian, in various examples. The family safety net platform may be configured to assign rules to the next generation user and the guardian associated with a linked account, in some examples.

In various embodiments, dynamically dividing proceeds from investment activity may include providing profit sharing of profits by the guardian and the next generation user from the investment activity. The profit sharing may be variable based on one or more milestones, in some embodiments. According to some examples, the method may include triggering notifications to the guardian or to the next generation user based on one or more thresholds related to the customized guardrails. The one or more thresholds may be calculated or based on input from the next generation user or the guardian, in various examples. In various embodiments, providing limited access by the next generation user to the guardian account includes providing access to use funds from the guardian account as collateral for the investment activity. According to various embodiments, the method may include using machine learning or artificial intelligence.

Various embodiments include a computing system with one or more processors and a data storage system in communication with the one or more processors, wherein the data storage system comprises instructions thereon that, when executed by the one or more processors, causes the one or more processors to execute the steps of the methods of FIGS. 1A-1B. In some examples, the machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. Other types of machine learning models may be used without departing from the scope of the present subject matter. In some examples, the family safety net platform may use a blockchain and/or smart contracts to implement the guardrails and/or milestones.

Various embodiments include a non-transitory computer-readable storage medium, the non-transitory computer-readable storage medium including instructions that, when executed by computers, cause the computers to perform operations including the methods of FIGS. 1A-1B. In various embodiments, the present system runs simulations to train the machine learning models, and to identify process improvements and optimization from simulated family safety net platforms. Training of the models may be accomplished online or offline, in various embodiments.

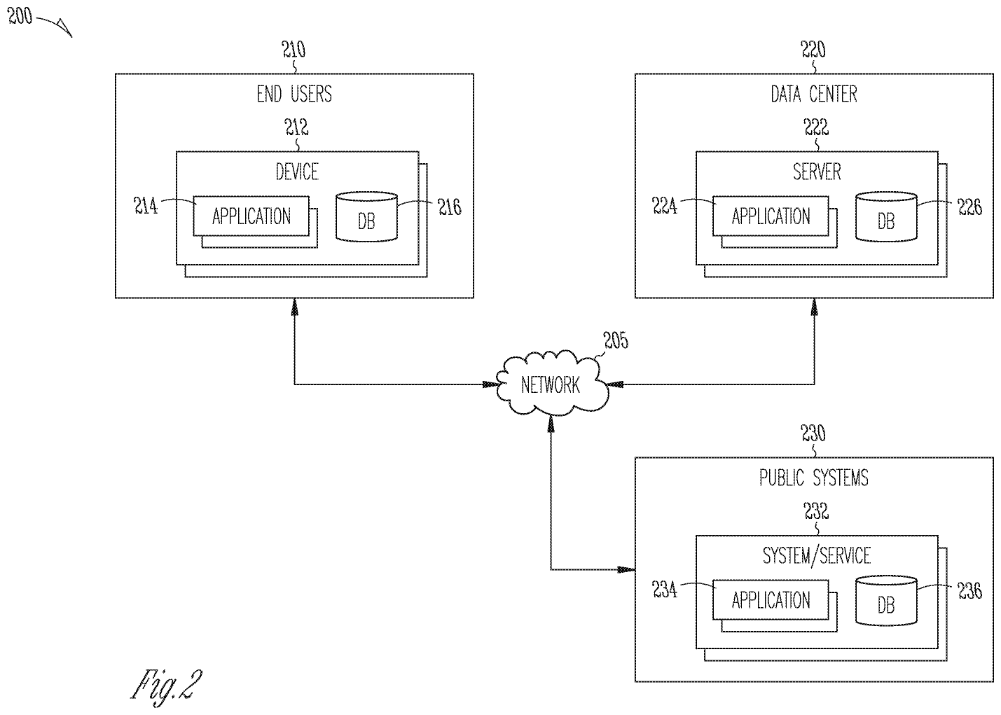

FIG. 2 illustrates an exemplary infrastructure for providing a system of the present subject matter. The infrastructure may comprise a distributed system 200 that may include a client-server architecture or cloud computing system. Distributed system 200 may have one or more end users 210, such as a next generation user and/or a guardian user. An end user 210 may have various computing devices 212, which may be a machine 500 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The server 222 or other portions of the distributed system may create and manage the safety net platform, such as by performing operations including the methods of FIGS. 1A-1B, in various embodiments. The business entity may be a computer service provider, as may be the case for a cloud services provider, or it may be a consumer product or service provider, such as a retailer. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 500.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 500.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured.

For example, some or all of the techniques described herein may operate on these cloud infrastructure control servers. Alternatively, or in addition, some or all of the techniques described herein may operate on the servers 222.

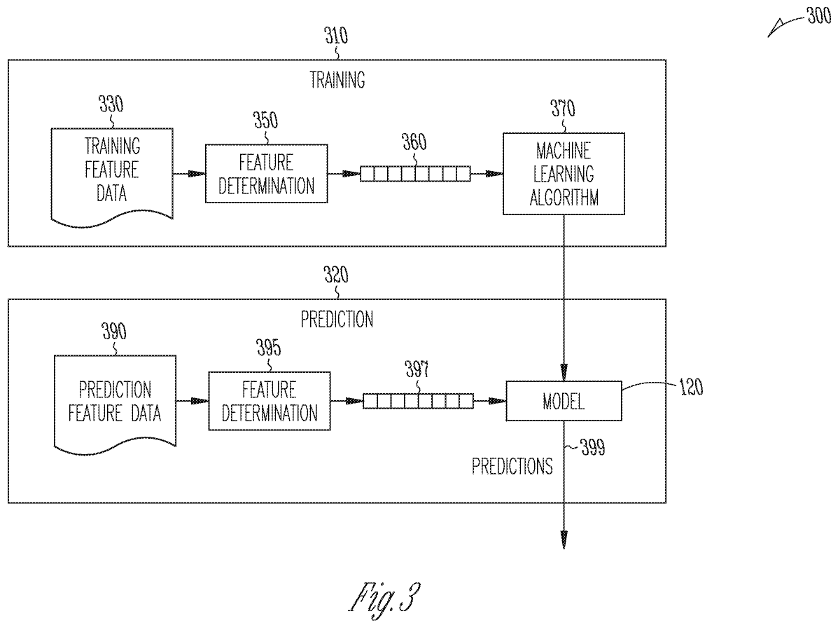

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine.

Machine learning module 300 utilizes a training module 310 and a prediction module 320. Training module 310 inputs training feature data 330 into feature determination module 350. The training feature data 330 may include data determined to be predictive of customized guardrails or milestones for a family advisor safety net. Categories of training feature data may include user input data, financial data of a guardian user, financial data of a dependent user, social media data, other third-party data, or the like. Specific training feature data and prediction feature data 390 may include, for example one or more of: interests, activities or occupations of the next generation user of financial services, and the like.

Feature determination module 350 selects training vector 360 from the training feature data 330. The selected data may fill training vector 360 and comprises a set of the training feature data that is determined to be predictive of customized guardrails or milestones for a family advisor safety net. In some examples, the tasks performed by the feature determination module 350 may be performed by the machine learning algorithm 370 as part of the learning process. Feature determination module 350 may remove one or more features that are not predictive of identifying customized guardrails or milestones for a family advisor safety net to train the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as customized guardrails or milestones for a family advisor safety net. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation- maximization algorithms, vector quantization, and information bottleneck method. In various embodiments, smart contracts or blockchain may be used to calculate and/or implement customized guardrails or milestones for a family advisor safety net.

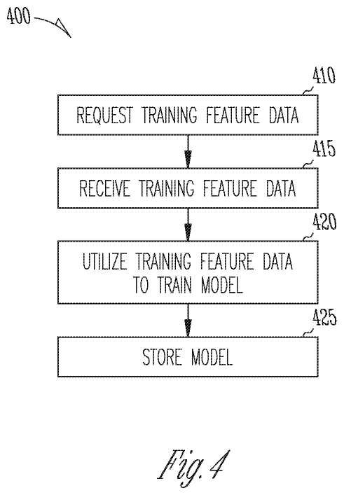

FIG. 4 illustrates a flowchart of a method 400 of training a model for a family safety net tool, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions.

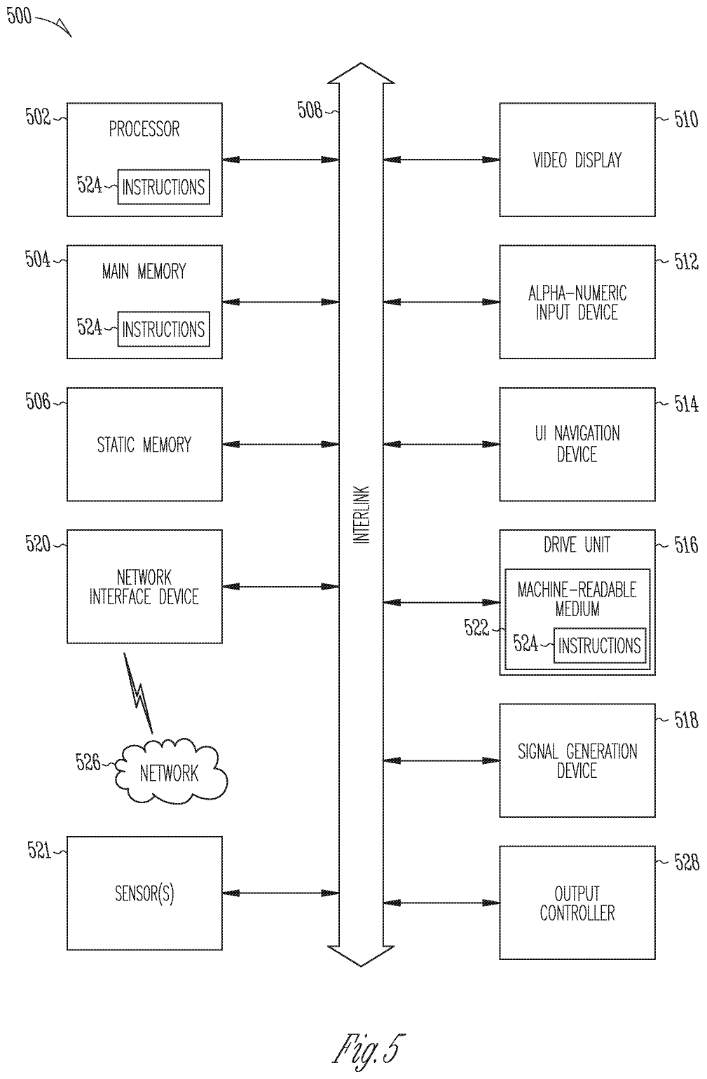

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may implement one or more of the training and prediction modules 310, 320 (e.g., as software or dedicated hardware) and may be configured to perform the methods of FIGS. 1A, 1B and 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a computer-implemented method including receiving, by a computer system, a next generation input indicating desired investment activity of a next generation user and identity of a guardian of the next generation user, receiving, by the computer system, a guardian account input including information regarding an account of the guardian to be used by the next generation user and associated guardrail information, generating, by the computer system, a family safety net platform by linking the next generation user to the guardian account for the desired investment activity, calculating, by the computer system, customized guardrails for the family safety net platform using the associated guardrail information, providing, by the computer system, limited access by the next generation user to the guardian account using the customized guardrails for the family safety net platform, and dynamically dividing, by the computer system, proceeds from investment activity of the next generation user between the guardian and the next generation user.

In Example 2, the subject matter of Example 1 optionally includes wherein calculating customized guardrails for the family safety net platform includes determining an allocated portion of funds in the guardian account accessible by the next generation user.

In Example 3, the subject matter of Example 1 optionally includes wherein calculating the customized guardrails for the family safety net platform includes using a blockchain.

In Example 4, the subject matter of Example 1 optionally includes wherein calculating the customized guardrails for the family safety net platform includes using smart contracts.

In Example 5, the subject matter of Example 1 optionally includes wherein providing limited access by the next generation user to the guardian account includes calculating one or more milestones, wherein the next generation user is provided access to an increased portion of funds in the guardian account if the one or more milestones are achieved.

In Example 6, the subject matter of Example 5 optionally includes wherein calculating the one or more milestones for the family safety net platform includes using a blockchain.

In Example 7, the subject matter of Example 5 optionally includes wherein calculating the one or more milestones for the family safety net platform includes using smart contracts. In Example 8, the subject matter of Example 5 optionally includes

wherein the one or more milestones include a percent return on investment or a value of profit earned from the investment activity.

In Example 9, the subject matter of Example 1 optionally includes wherein the investment activity of the next generation user includes investment in a financial instrument, and wherein the next generation user is prevented from investing funds from the guardian account in the financial instrument if a value of the financial instrument falls below a threshold amount.

Example 10 is a system including: a computing system comprising one or more processors and a data storage system in communication with the one or more processors, wherein the data storage system comprises instructions thereon that, when executed by the one or more processors, causes the one or more processors to: receive a next generation input indicating desired investment activity of a next generation user and identity of a guardian of the next generation user; receive a guardian account input including information regarding an account of the guardian to be used by the next generation user and associated guardrail information; generate a family safety net platform by linking the next generation user to the guardian account for the desired investment activity; calculate customized guardrails for the family safety net platform using the associated guardrail information; provide limited access by the next generation user to the guardian account using the customized guardrails for the family safety net platform, and dynamically divide proceeds from investment activity of the next generation user between the guardian and the next generation user.

In Example 11, the subject matter of Example 10 optionally includes wherein the computing system is configured to enforce one or more rules for the investment activity according to the customized guardrails.

In Example 12, the subject matter of Example 10 optionally includes wherein the computer system is configured to use the customized guardrails to control or prevent use of collective funds of the guardian and the next generation user for selected investments under programmable conditions.

In Example 13, the subject matter of Example 10 optionally includes wherein the computer system is configured to assign rules to the next generation user and the guardian associated with a linked account.

In Example 14, the subject matter of Example 10 optionally includes wherein dynamically dividing proceeds from investment activity includes providing profit sharing of profits by the guardian and the next generation user from the investment activity.

In Example 15, the subject matter of Example 14 optionally includes wherein the profit sharing is variable based on one or more milestones.

Example 16 is a non-transitory computer-readable storage medium, the non-transitory computer-readable storage medium including instructions that, when executed by computers, cause the computers to perform operations of: receiving a next generation input indicating desired investment activity of a next generation user and identity of a guardian of the next generation user; receiving a guardian account input including information regarding an account of the guardian to be used by the next generation user and associated guardrail information; generating a family safety net platform by linking the next generation user to the guardian account for the desired investment activity; calculating customized guardrails for the family safety net platform using the associated guardrail information; providing limited access by the next generation user to the guardian account using the customized guardrails for the family safety net platform; and dynamically dividing proceeds from investment activity of the next generation user between the guardian and the next generation user.

In Example 17, the subject matter of Example 16 optionally includes wherein the non-transitory computer-readable storage medium further includes instructions that, when executed by computers, cause the computers to perform operations of: triggering notifications to the guardian or to the next generation user based on one or more thresholds related to the customized guardrails.

In Example 18, the subject matter of Example 16 optionally includes wherein providing limited access by the next generation user to the guardian account includes providing access to use funds from the guardian account as collateral for the investment activity.

In Example 19, the subject matter of Example 16 optionally includes wherein calculating the customized guardrails for the family safety net platform includes using a blockchain.

In Example 20, the subject matter of Example 16 optionally includes wherein calculating the customized guardrails for the family safety net platform includes using smart contracts.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
receiving, by a computer system, a next generation input indicating desired investment activity of a next generation user and identity of a guardian of the next generation user;
receiving, by the computer system, a guardian account input including information regarding an account of the guardian to be used by the next generation user and associated guardrail information;
generating, by the computer system, a family safety net platform by linking the next generation user to the guardian account for the desired investment activity;
calculating, by the computer system, customized guardrails for the family safety net platform using the associated guardrail information, wherein calculating the customized guardrails includes using machine learning to determine an allocated portion of funds in the guardian account accessible by the next generation user, wherein the machine learning includes using feature determination modules that perform data standardization operations, and the machine learning includes using one hot encoding for converting categorical data into numerical representations;
providing, by the computer system, limited access by the next generation user to the guardian account using the customized guardrails for the family safety net platform, wherein providing limited access includes providing a selectable level of oversight by the guardian over the next generation user; and
dynamically dividing, by the computer system, proceeds from investment activity of the next generation user between the guardian and the next generation user.

2. The computer-implemented method of claim 1, wherein the desired investment activity includes a crypto-currency investment by the next generation user.

3. The computer-implemented method of claim 1, wherein calculating the customized guardrails for the family safety net platform includes using a blockchain.

4. The computer-implemented method of claim 1, wherein calculating the customized guardrails for the family safety net platform includes using smart contracts.

5. The computer-implemented method of claim 1, wherein providing limited access by the next generation user to the guardian account includes calculating one or more milestones, wherein the next generation user is provided access to an increased portion of funds in the guardian account if the one or more milestones are achieved.

6. The computer-implemented method of claim 5, wherein calculating the one or more milestones for the family safety net platform includes using a blockchain.

7. The computer-implemented method of claim 5, wherein calculating the one or more milestones for the family safety net platform includes using smart contracts.

8. The computer-implemented method of claim 5, wherein the one or more milestones include a percent return on investment or a value of profit earned from the investment activity.

9. The computer-implemented method of claim 1, wherein the investment activity of the next generation user includes investment in a financial instrument, and wherein the next generation user is prevented from investing funds from the guardian account in the financial instrument if a value of the financial instrument falls below a threshold amount.

10. A system comprising:
a computing system comprising one or more processors and a data storage system in communication with the one or more processors, wherein the data storage system comprises instructions thereon that, when executed by the one or more processors, causes the one or more processors to:
receive a next generation input indicating desired investment activity of a next generation user and identity of a guardian of the next generation user;
receive a guardian account input including information regarding an account of the guardian to be used by the next generation user and associated guardrail information;
generate a family safety net platform by linking the next generation user to the guardian account for the desired investment activity;
calculate customized guardrails for the family safety net platform using the associated guardrail information, wherein calculating the customized guardrails includes using machine learning to determine an allocated portion of funds in the guardian account accessible by the next generation user, wherein the machine learning includes using feature determination modules that perform data standardization operations, and the machine learning includes using one hot encoding for converting categorical data into numerical representations;
provide limited access by the next generation user to the guardian account using the customized guardrails for the family safety net platform, wherein providing limited access includes providing a selectable level of oversight by the guardian over the next generation user; and
dynamically divide proceeds from investment activity of the next generation user between the guardian and the next generation user.

11. The system of claim 10, wherein the computing system is configured to enforce one or more rules for the investment activity according to the customized guardrails.

12. The system of claim 10, wherein the computer system is configured to use the customized guardrails to control or prevent use of collective funds of the guardian and the next generation user for selected investments under programmable conditions.

13. The system of claim 10, wherein the computer system is configured to assign rules to the next generation user and the guardian associated with a linked account.

14. The system of claim 10, wherein dynamically dividing proceeds from investment activity includes providing profit sharing of profits by the guardian and the next generation user from the investment activity.

15. The system of claim 14, wherein the profit sharing is variable based on one or more milestones.

16. A non-transitory computer-readable storage medium, the non- transitory computer-readable storage medium including instructions that, when executed by computers, cause the computers to perform operations of:
receiving a next generation input indicating desired investment activity of a next generation user and identity of a guardian of the next generation user;
receiving a guardian account input including information regarding an account of the guardian to be used by the next generation user and associated guardrail information;
generating a family safety net platform by linking the next generation user to the guardian account for the desired investment activity;
calculating customized guardrails for the family safety net platform using the associated guardrail information, wherein calculating the customized guardrails includes using machine learning to determine an allocated portion of funds in the guardian account accessible by the next generation user, wherein the machine learning includes using feature determination modules that perform data standardization operations, and the machine learning includes using one hot encoding for converting categorical data into numerical representations;
providing limited access by the next generation user to the guardian account using the customized guardrails for the family safety net platform, wherein providing limited access includes providing a selectable level of oversight by the guardian over the next generation user, and
dynamically dividing proceeds from investment activity of the next generation user between the guardian and the next generation user.

17. The non-transitory computer-readable storage medium of claim 16, wherein the non-transitory computer-readable storage medium further includes instructions that, when executed by computers, cause the computers to perform operations of:
triggering notifications to the guardian or to the next generation user based on one or more thresholds related to the customized guardrails.

18. The non-transitory computer-readable storage medium of claim 16, wherein providing limited access by the next generation user to the guardian account includes providing access to use funds from the guardian account as collateral for the investment activity.

19. The non-transitory computer-readable storage medium of claim 16, wherein calculating the customized guardrails for the family safety net platform includes using a blockchain.

20. The non-transitory computer-readable storage medium of claim 16, wherein calculating the customized guardrails for the family safety net platform includes using smart contracts.
